(19) United States
(12) Patent Application Publication
(10) Pub. No.: US 2005/0193195 A1
(43) Pub. Date: Sep. 1, 2005

(54) Method and system for protecting data of storage unit

(75) Inventors: Kuen-Tsan Wu, Taipei (TW); Jung-Hsun Yu, Taipei (TW); Yu-Cheng Sheng, Taipei (TW)

Correspondence Address: Mr. William F. Nixon;SQUIRE SANDERS & DEMPSEY LLP, 14th Floor, 8000 Towers Crescent Drive, Tysons Corner, VA, 22182-2700, US

(73) Assignee: Foquest Advanced, Inc.

(21) Appl. No.: 10/787,975

(22) Filed: Feb. 27, 2004

(51) Int. Cl. H04L 9/00

(52) U.S. Cl. 713/165

(57) ABSTRACT

A method and a system for protecting data of a storage unit are disclosed for use in a data processing device. A user identification module encodes and encrypts a password preset by the user and stores the encoded and encrypted password into the storage unit. Next, the user identification module encodes and encrypts partition table data read from a memory unit and stores the encoded and encrypted partition table data in a predetermined location of the storage unit. Then, the user identification module deletes the partition table data stored in the memory unit. Finally, when the user re-starts power of the data processing device and inputs a password consistent with the preset password, the user identification module decodes and decrypts the partition table data stored in the storage unit and writes the decoded and decrypted partition table data to the memory unit to thereby perform booting operation.

### BACKGROUND OF THE INVENTION

1. Field of the Invention

The present invention generally relates to methods and systems for protecting data of storage units, and more particularly, to a method and a system for protecting data stored in a data processing device that has a hard disk drive storage unit.

2. Description of the Related Art

Due to the advancements in electronic and information technology, data processing devices, such as personal computers and notebook computers, have already become an indispensable part of our daily life. The data processing device is not only used for compilation and execution of programs or purely for data processing, but also serves as a communication medium for multimedia data such as audio, video, or a combination of both, allowing the user of the data processing device to edit and play the multimedia data. On the other hand, the environment of wireless and cable communication is getting more and more mature and the physical dimension of the data processing device is getting smaller and smaller, thus mobile information access is becoming more and more convenient. Correspondingly, the user of a data processing device is increasingly more willing to search and retrieve information by using a data processing device that connects with a network and has a function for data transmission.

Although users enjoy the convenience of fast data transmission using a data processing device as mentioned above, users feel anxious about data security and system designers are obliged to address this concern. In comparison to the period when most information was recorded on pieces of paper, a data processing device presently comprises a large storage component, e.g. a hard disk drive, which can record a huge volume of words, images or video-audio files. Even though the physical volume of documents has thus been largely reduced, the simplicity of stealing and duplicating data has also increased significantly. For example, a third party can duplicate or transfer desired data by performing the simple step of file duplication via a floppy disk drive, CD-ROM burner, or even through a network.

The technology of data protection for a data processing device disclosed in the prior art does not go beyond the following. In the power-on process where a data processing device is booted, the Basic Input Output System (BIOS) prompts the user to enter a password, which was input via the security function provided by the BIOS. The password is verified for the user's authority to use this data processing device. And if the user has the authority to use the data processing device, the booting procedure then continues. Another form of data protection establishes a user-select password associated with the working environment or stored data of each user after the operating system is loaded. The operating system then provides access to the working environment or the stored data corresponding to the entered password of each user.

However, by using the protection method provided by the BIOS, a third party can easily reset the security data stored in the BIOS by only connecting the BIOS Reset Jumper on the motherboard and/or disconnecting the battery on the motherboard and reconnecting it afterwards. Also, by using the protection method implemented by the operating system, data in the hard disk drive can still be read if the data processing device was booted via a floppy disk or a CD. Both of the above protection methods fail to achieve ideal protection of stored data and programs.

### SUMMARY OF THE INVENTION

In order to solve the foregoing disadvantages of the prior art, a primary objective of the present invention is to provide a method and a system for protecting data of a storage unit, which can encrypt the partition table in the storage unit to prevent unauthorized use of an operating system and access of data.

Another objective of the present invention is to provide a method and a system for protecting data of a storage unit, whereby protection for data of a storage unit is achieved through only a software or hardware control mechanism.

In order to achieve the above and other objectives, the present invention provides a system for protecting data of a storage unit, which system includes a central processing unit capable of performing signal retrieving, encoding-decoding and command execution; at least a memory unit to store software programs of a data processing device having the storage unit; a specific location resided in the memory unit, to encode, encrypt and store the password set by user into the storage unit; and a user identification module, to encode, encrypt and store the data of partition table into the specific location of a storage unit, and to retrieve and decode the data of the partition table from the storage unit and recover the data to the correct location of the partition table, so that the data processing device can proceed to the normal booting procedure.

By installing the user identification module into the memory unit, the method for protecting data of a storage unit can be executed via the above-mentioned system for protecting data of a storage unit according to the following steps. First, the user identification module encodes and encrypts the user-set password and stores the result to a specific location of the storage unit. Then, the user identification module encodes and encrypts the data of the partition table and stores the result to a designated location in the storage unit. Next, the user identification module deletes the data of the partition table. Finally, the user identification module identifies whether the password input by user is correct or not, after the user reboots the data processing device. If the password is correct, the user identification module then decodes and decrypts the encoded and encrypted data of partition table and recovers the data to the correct location of the partition table so that the normal booting procedure can be performed. Otherwise, the normal booting procedure is terminated.

According to the method and system for protecting data of a storage unit in the present invention, a user identification mechanism is executed during the booting procedure to prevent an unauthorized user from turning on the data processing device and accessing the data stored in the storage unit.

### BRIEF DESCRIPTION OF THE DRAWINGS

The present invention can be more fully understood by reading the following detailed description of the preferred embodiments, with reference made to the accompanying drawings wherein:

FIG. 1 is a schematic diagram illustrating a system layout for applying a system for protecting data of a storage unit to a personal computer according to the present invention;

FIG. 2 is a block diagram illustrating mutual interaction between units and the user identification module in the system for protecting data of a storage unit according to the present invention; and

FIGS. 3A and 3B are flow charts illustrating steps involved in a method for protecting data of a storage unit according to the present invention.

### DETAILED DESCRIPTION OF THE PREFERRED EMBODIMENTS

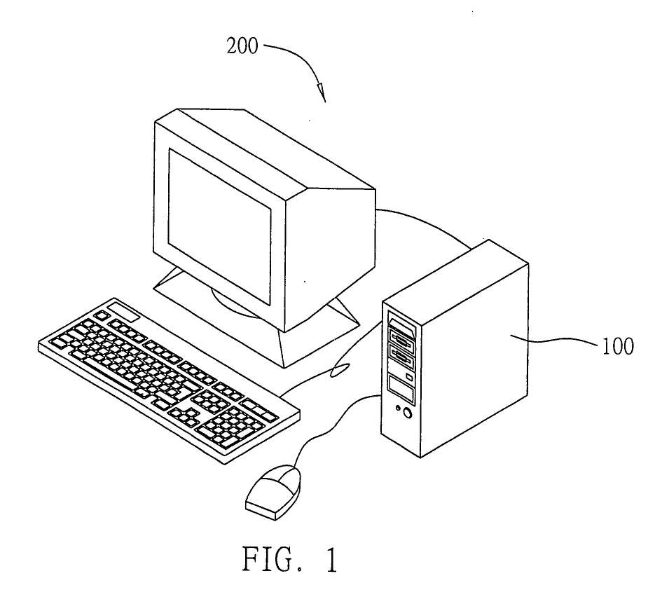

In FIG. 1, a system 100 for protecting data of a storage unit is illustrated in accordance with an embodiment of the present invention. The system 100 is applied to a conventional layout of a personal computer 200. In the following, only the units and modules related to the system 100 of the present invention are described for simplification purpose. The descriptions of input units, e.g. keyboard or mouse, and display unit, e.g. monitor, are thus omitted.

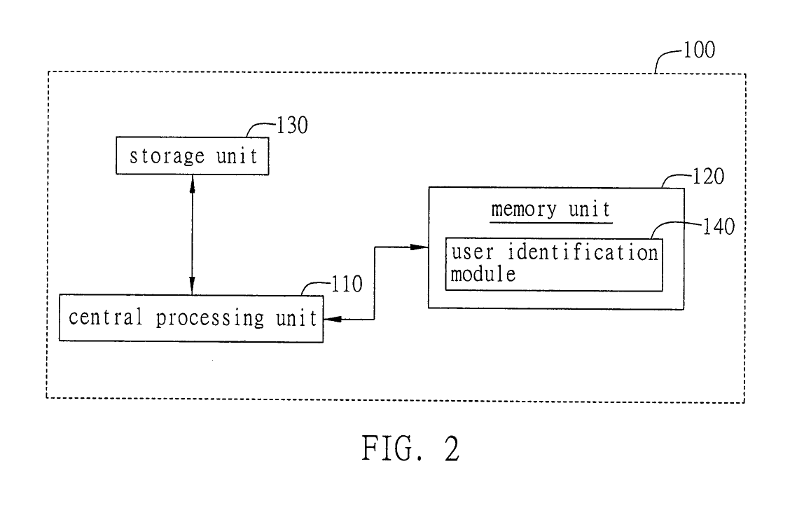

Referring to FIG. 2, the system 100 includes a central processing unit 110, a memory unit 120, a storage unit 130, and a user identification module 140.

The central processing unit 110 provides the system 100 with functions of retrieving signals, encoding-decoding and command execution. It may also transfer and receive data from other resources via data transmission routes, e.g. a data bus.

The memory unit 120 provides the system 100 for data protection of a storage unit with storage of the BIOS and other software programs and/or resident programs. The property of the memory unit is non-volatile; i.e. the data stored in memory unit will not disappear even after the working power of the personal computer 200 is turned off. This enables the execution of the resident BIOS program and the power-on procedure of a personal computer 200 after the user turns on the working power of the personal computer 200. Also, the memory unit 120 may be an Electrically Erasable Programmable Read Only Memory (EEPROM) or a Flash Memory or the like. Since the memory described above is rewritable, the user may update, for example, the BIOS, depending on each particular embodiment.

The storage unit 130 provides the personal computer 200 with storage of the operating system or other programs or data. In this particular embodiment, the storage unit 130 is a Hard Disk, the function and structure of which is detailed in the prior art, and the description of which is thus omitted.

The user identification module 140 is a software program residing in the memory unit, which encodes and encrypts, by using the central processing unit 110, the password input by the user and stores the encoded and encrypted password into a specific location of the storage unit 130. In addition, the user identification module 140 may also encode and encrypt, by using the central processing unit 110, the data of the partition table and store the result into a specific location of the storage unit 130. After the user reboots the personal computer 200 and enters a correct password in the booting procedure, the data of partition table is retrieved from the storage unit 130. The central processing unit 110 then decodes and recovers the encoded data, and recovers the data to the correct location of the partition table, so that the personal computer 200 is allowed to perform the normal booting procedure.

In this particular embodiment, the partition table indicates the partition table of the storage unit 130, i.e. the hard disk. A conventional hard disk comprises a plurality of clusters, heads, and sectors wherein each sector has a fixed number of bytes. The first sector of the first head in the first cluster is defined as the partition, the beginning of which stores the master boot program (MBP) and the end of which stores the data of partition table.

The booting procedure of the personal computer 200 of the present invention is briefly described in the following. Program execution starts from address 0FFFF0H, i.e. CS=FFFF, IP=0000, of the memory unit 120. The program in the BIOS of the personal computer at the address of 0FFFF0H reads: “FFFF0: JMP START”. After the program has jumped to START, the ROM BIOS in the memory unit 120 starts some initial checks, for example, checking RAM, keyboard, monitor, disk drives, etc. Then the master boot program will be read, and the master boot program will take over the control from the BIOS and continue the execution. In summary, the procedure may be divided into the following steps. First of all, when a computer is booted, the BIOS is executed and the Master Boot Record (MBR) from the first sector of the storage unit 130 is written into the random access memory, and control is then transferred over to the program code in the MBR. Next, the program code in the MBR scans the entire primary partition table, puts a flag in the first partition, and labels the partition as bootable. Then, the program code is copied into the random access memory and control is transferred over to the program code in the partition. The system files, such as IO.SYS and MSDOS.SYS in MS-DOS, are then loaded into the random access memory by the boot program, and control is transferred over to the loaded system files.

Accordingly, in the booting procedure of a personal computer 200, the data of partition table is indispensable. Without the data of the partition table, the system would not know how the storage unit 130 was partitioned as well as the storage location of the operating system, such as Windows XP or LINUX, and consequently, the booting procedure would not be completed.

Therefore, based on this feature of the partition table, the user identification module 140 may interrupt an unauthorized user during the booting procedure by deleting the data of the partition table, thus protecting the data stored in the storage unit 130 of the personal computer 200.

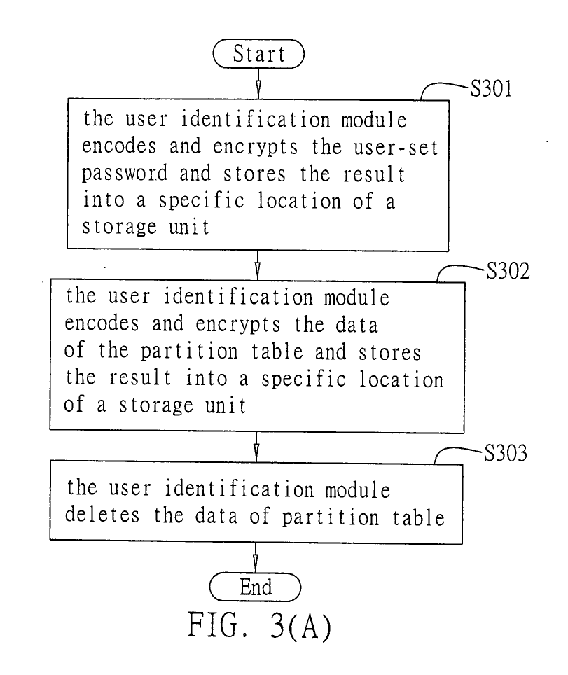

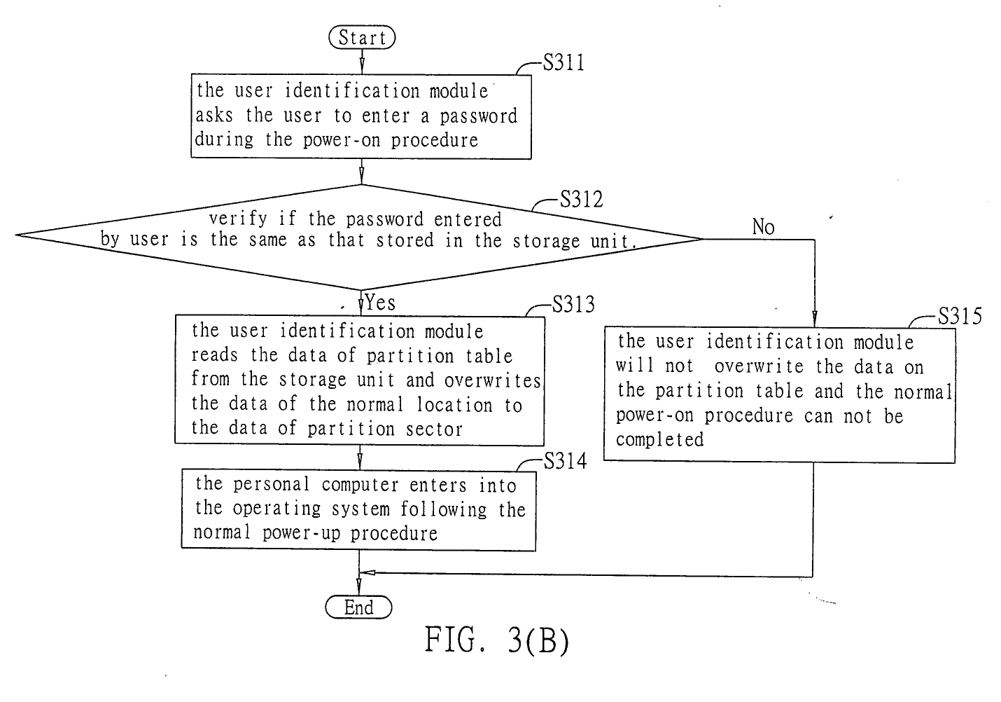

FIG. 3A is a flow chart illustrating steps involved in a method for protecting data of a storage unit 130 according to the present invention. The user is prompted to install the user identification module 140 in the memory unit 120 when the personal computer 200 is operating under the normal operating system.

In step S301, the user identification module 140 encodes and encrypts password input by the user and stores the encoded and encrypted password into a specific location of the storage unit 130. In this particular embodiment, after the user identification module 140 is installed in the memory module 120, the user identification module 140 prompts the user to select a password, which can be a combination of numbers, characters, and symbols. After the password has been selected, the user identification module 140 then encodes and encrypts the password and stores the encoded and encrypted password into a specific location of the storage unit 130 before proceeding to step S302.

In step S302, the user identification module 140 encodes and encrypts the data of partition table and stores the result into a specific location of the storage unit 130. In this particular embodiment, after completing the execution of the step of password encryption by the user identification module 140, the data of partition table in the partition sector is also encrypted and stored into another specific location of the storage unit 130, before proceeding to step S303.

In step S303, the user identification module 140 deletes the data of partition table. In this particular embodiment, the data of partition table is deleted from the memory unit 120 after the step of encrypting and storing the data of the partition table is completed by the user identification module 140. Since the data of partition table has been deleted from the memory unit 120, if no correct password is entered after the user reboots the personal computer 200 during the booting procedure, then the data of partition table will not be recovered to the correct partition sector, thus the normal booting procedure of the personal computer 200 can not be completed. The actual operation steps are described in the following.

FIG. 3B is a flow chart illustrating steps of identity verification after the personal computer 200 completes the data protection setup procedure and is rebooted.

In step S311, the user identification module 140 prompts the user to input a password during the booting operation, before proceeding to step S312.

In step S312, the user identification module 140 verifies the password input by the user to determine if the password is the same as that stored in the storage unit 130. If the input password is the same as that stored in the storage unit 130, then proceed to step S313. Otherwise, proceed to step S315.

In step S313, the user identification module 140 reads the data of the partition table from the storage unit 130 and recovers the data to the correct location of the partition sector, and then proceeds to step S314.

In step S314, the personal computer 200 enters the operating system following the normal booting operation, so that the authorized user can access the data in the storage unit 130.

In step S315, wherein the user does not enter a correct password in step S311, the user identification module 140 does not execute the step of overwriting the data of partition table. Correspondingly, the boot program does not retrieve data of the partition sector required to load the data of the operating system from the storage unit 130, thus the normal booting operation is not executed and unauthorized access of data in the storage unit 130 is prevented.

In summary, the method and system for protecting data of a storage unit according to the present invention prevent an unauthorized user from booting the personal computer 200 and accessing the data in the storage unit 130 through a user identification mechanism executed in the power-on procedure. Even if an unauthorized user without the password dismantled the storage unit 130, data access is prohibited even if using the storage unit 130 with another computer device Thus, this achieves the purpose of data protection.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims. For example, besides the personal computer as described in the embodiment, the invention is equally applicable to notebook, server, workstation, and other devices having the storage unit.

1. A method for protecting data of a storage unit, applicable to a data processing device having the storage unit, the method comprising the steps of:
having a user identification module encode and encrypt a password preset by a user and store the encoded and encrypted password in a predetermined location of the storage unit;
having the user identification module encode and encrypt partition table data read from a memory unit and store the encoded and encrypted partition table data in a predetermined location of the storage unit;
having the user identification module delete the partition table data stored in the memory unit; and
having the user identification module determine if a password input by the user, who re-starts power of the data processing device, is consistent with the preset password; if yes, decoding and decrypting the partition table data stored in the storage unit, and writing the decoded and decrypted partition table data to the memory unit so as to allow booting operation to be performed; if no, terminating the booting operation.

2. The method of claim 1, wherein the storage unit is one selected from the group consisting of a built-in hard disk, external hard disk, and removable hard disk.

3. The method of claim 1, wherein the data processing device is one selected from the group consisting of a personal computer, notebook computer, tablet computer, liquid crystal display computer, server, and workstation.

4. The method of claim 1, wherein the user identification module is a software program installed in the memory unit and performs user identification when the data processing device is booted.

5. The method of claim 1, wherein the memory unit is an Electronic Erasable Programmable Read Only Memory (EEPROM) or a flash memory.

6. The method of claim 1, wherein the password is one selected from the group consisting of characters, numbers, symbols, a combination of characters and numbers, a combination of characters and symbols, a combination of symbols and numbers, and a combination of symbols, numbers and characters.

7. A system for protecting data of a storage unit, applicable to a data processing device having the storage unit, the system comprising:
a central processing unit for retrieving signals, encoding/decoding, and executing commands for the system;
a memory unit for storing a Basic Input/Output System (BIOS) and other software programs of the data processing device;
the storage unit for storing system operating programs and other programs and data of the data processing device; and
a user identification module residing in the memory unit, for encoding and encrypting a password preset by the user and storing the encoded and encrypted password in a predetermined location of the storage unit; the user identification module also for encoding and encrypting partition table data read from the memory unit, storing the encoded and encrypted partition table data in a predetermined location of the storage unit, and deleting the partition table data stored in the memory unit, and for retrieving the stored partition table data from the storage unit and decoding and decrypting the retrieved partition table data to be written to the memory unit when the user inputs a password consistent with the preset password during rebooting operation.

8. The system of claim 7, wherein the storage unit is one selected from the group consisting of a built-in hard disk, external hard disk, and removable hard disk.

9. The system of claim 7, wherein the data processing device is one selected from the group consisting of a personal computer, notebook computer, tablet computer, liquid crystal display computer, server, and workstation.

10. The system of claim 7, wherein the user identification module is a software program installed in the memory unit and performs user identification when the data processing device is booted.

11. The system of claim 7, wherein the memory unit is an Electronic Erasable Programmable Read Only Memory (EEPROM) or a flash memory.

12. The system of claim 7, wherein the password is one selected from the group consisting of characters, numbers, symbols, a combination of characters and numbers, a combination of characters and symbols, a combination of symbols and numbers, and a combination of symbols, numbers and characters.
